(19) United States
(12) Patent Application Publication
(10) Pub. No.: US 2014/0189394 A1
(43) Pub. Date: Jul. 3, 2014

(54) ELECTRONIC DEVICE AND POWER-SUPPLY CONTROL METHOD

(71) Applicant: Kabushiki Kaisha Toshiba, Tokyo (JP)

(72) Inventors: Kinji Taki, Ome-shi (JP); Tooru Mamata, Akiruno-shi (JP)

(73) Assignee: Kabushiki Kaisha Toshiba, Tokyo (JP)

(21) Appl. No.: 14/011,594

(22) Filed: Aug. 27, 2013

Related U.S. Application Data
(63) Continuation of application No. PCT/JP2013/058108, filed on Mar. 21, 2013.

(30) Foreign Application Priority Data
Dec. 27, 2012 (JP) 2012-285660

(51) Int. Cl. G06F 1/32; G06F 1/26

(52) U.S. Cl. CPC G06F 1/3296; G06F 1/263
USPC 713/320

(57) ABSTRACT

According to one embodiment, a electronics device includes a setting module, a determination module, a control module. The setting module is configured to set a power consumption reference value for a predetermined period of time. The determination module is configured to determine whether an amount of power consumption of an external power supply exceeds the power consumption reference value in the predetermined period of time. The control module is configured to cause a power reduction process to be performed when the amount of power consumption is determined as exceeding the power consumption reference value, the power reduction process reducing the amount of power consumption of the external power supply.

### CROSS-REFERENCE TO RELATED APPLICATIONS

This application is a Continuation application of PCT Application No. PCT/JP2013/058108, filed Mar. 21, 2013 and based upon and claiming the benefit of priority from Japanese Patent Application No. 2012-285660, filed Dec. 27, 2012, the entire contents of all of which are incorporated herein by reference.

### FIELD

Embodiments described herein relate generally to an electronic device for performing power-saving control and a power-supply control method.

### BACKGROUND

An electronic device such as a notebook-type personal computer can be powered either by a battery or an external power supply (AC power supply). Such an electronic device can therefore be used on the desk by AC power, or used in other locations by battery power.

Such an electronic device is equipped with a peak shift function, which reduces the amount of power consumption (amount of consumption of power from an AC power supply) during a period of time with high demand for electricity. The peak shift function stops supply from an AC power supply and switches to battery power at the start of a peak shift period set in advance, thereby reducing the amount of consumption of power from the AC power supply.

A peak shift function of the conventional technique causes an electronic device to switch to battery power during a peak shift period. Therefore, at the point in time immediately after the peak shift time has ended, the remaining amount of charge of the battery is small. This reduces the period of time during which the electronic device can be powered by the battery at the point in time immediately after the peak shift time has ended.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates an outer configuration of an electronic device according to an embodiment.

FIG. 2 illustrates a system configuration of a personal computer 10 according to the embodiment.

FIG. 3 illustrates a relationship of modules relating to a peak shift function of the embodiment.

FIG. 4 is an exemplary diagram illustrating a peak shift setting screen of the embodiment.

FIG. 5 is an exemplary diagram illustrating a peak shift setting screen of the embodiment.

FIG. 6 is a flowchart illustrating power-saving control by the peak shift function of the embodiment.

FIG. 7 illustrates a condition in which the current amount of power consumption (W1) exceeds the maximum power consumption reference value (Wmax) according to the embodiment.

FIG. 8 illustrates a situation in which a power reduction cancellation process of the embodiment is performed.

### DETAILED DESCRIPTION

Various embodiments will be described hereinafter with reference to the accompanying drawings.

In general, according to one embodiment, a electronics device includes a setting module, a determination module, a control module. The setting module is configured to set a power consumption reference value for a predetermined period of time. The determination module is configured to determine whether an amount of power consumption of an external power supply exceeds the power consumption reference value in the predetermined period of time. The control module is configured to cause a power reduction process to be performed when the amount of power consumption is determined as exceeding the power consumption reference value, the power reduction process reducing the amount of power consumption of the external power supply.

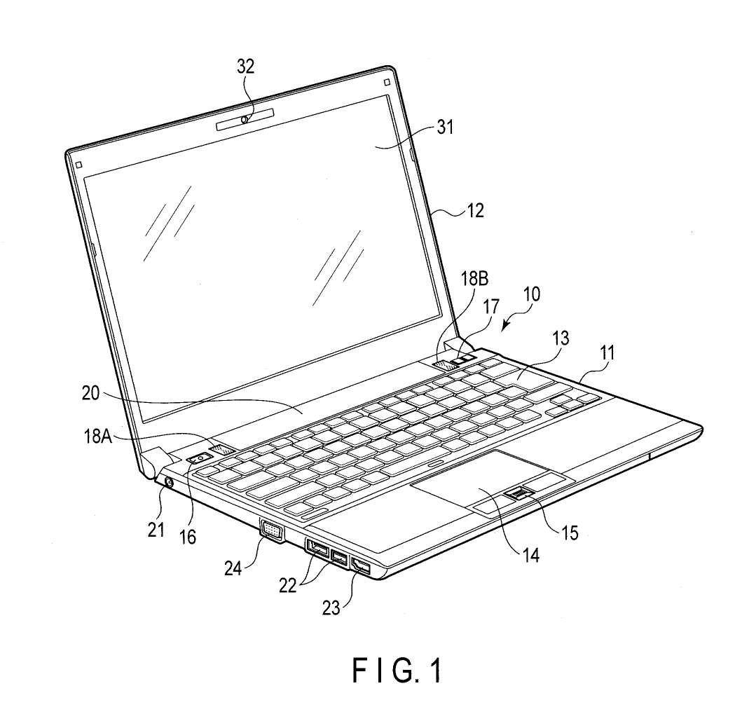

FIG. 1 illustrates an outer configuration of an electronic device according to the embodiment. The electronic device can be embodied by a notebook-type personal computer, a tablet terminal, a desktop-type personal computer, or the like, for example. In the description that follows, it is assumed that the electronic device is embodied as a notebook-type personal computer 10.

FIG. 1 is a perspective view illustrating the computer 10 viewed from the front in a state in which a display unit is open. The personal computer 10 includes a computer main body 11 and a display unit 12. The display unit 12 incorporates a display device such as a liquid crystal display (LCD) 31. Further, a camera (web camera) 32 is arranged at an upper end of the display unit 12.

The display unit 12 is attached to the computer main body 11 so as to be rotatable between an open position in which an upper surface of the computer main body 11 is exposed and a closed position in which an upper surface of the computer main body 11 is covered with the display unit 12. The computer main body 11 includes a thin, box-shaped housing. A keyboard 13, a touchpad 14, a fingerprint sensor 15, a power-supply switch 16 for powering on/off the personal computer 10, a plurality of function buttons 17, and speakers 18A and 18B are arranged on an upper surface of the housing.

A power-supply connector 21 is provided in the computer main body 11. The power-supply connector 21 is provided on a side surface, e.g., on a left side surface of the computer main body 11. An external power-supply device is removably connected to the power-supply connector 21. An AC adaptor can be used as the external power-supply device. An AC adaptor is a power-supply device which converts commercial external power (AC power) into DC power.

A battery 20 is removably attached to a rear end of the computer main body 11, for example. The battery 20 may be a built-in battery provided in the personal computer 10.

The personal computer 10 is driven by power from an external power-supply device or the battery 20 (AC-powered or battery-powered). If an external power-supply device is connected to the power-supply connector 21 of the personal computer 10, the personal computer 10 is driven by power from the external power-supply device. The power from the external power-supply device is also used to charge the battery 20. During a period of time in which the external power-supply device is not connected to the power-supply connector 21 of the personal computer 10, the personal computer 10 is driven by power from the battery 20.

Further, a plurality of USB ports 22, a High-Definition Multimedia Interface (HDMI) output terminal 23, and an RGB port 24 are provided in the computer main body 11.

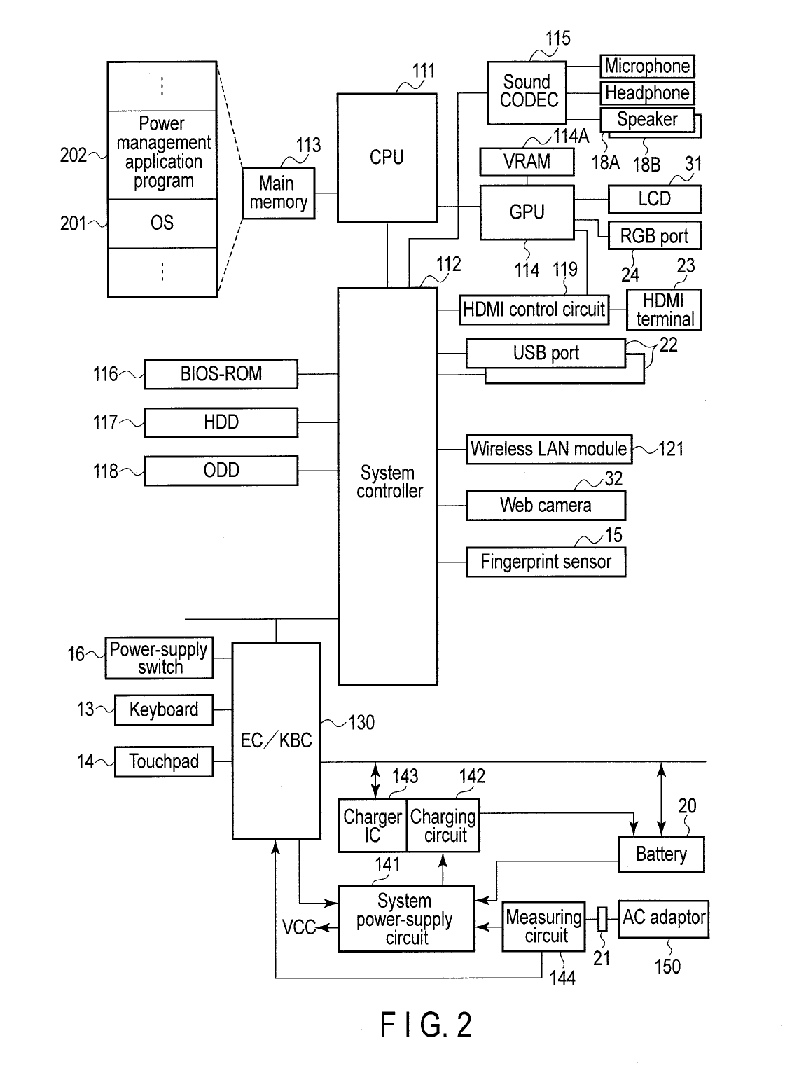

FIG. 2 illustrates a system configuration of the personal computer 10 according to the embodiment. The personal computer 10 includes a CPU 111, a system controller 112, a main memory 113, a graphics processing unit (GPU) 114, a sound codec 115, a BIOS-ROM 116, a hard disc drive (HDD) 117, an optical disc drive (ODD) 118, a wireless LAN module 121, an embedded controller/keyboard controller IC (EC/KBC) 130, a system power-supply circuit 141, a charging circuit 142, a charger IC 143, a measuring circuit 144, and the like.

The CPU 111 is a processor configured to control operation of each component of the personal computer 10. The CPU 111 performs a variety of programs loaded from the HDD 117 into the main memory 113. Such programs include an operating system (OS) 201 and application programs of various kinds. Such application programs include a power management application program 202. The power management application program 202 is a program for embodying a peak shift function. The peak shift function is a function for reducing the amount of power consumption (amount of consumption of power from the AC power supply) during a period of time with high demand for electricity.

Further, the CPU 111 executes a basic input/output system (BIOS) stored in the BIOS-ROM 116, which is a non-volatile memory. The BIOS is a system program configured to control hardware.

The GPU 114 is a display controller configured to control the LCD 31, which is used as a display monitor of the personal computer 10. The GPU 114 generates a display signal (LVDS signal) to be supplied to the LCD 31 on the basis of display data stored in the video memory (VRAM) 114A. Further, the GPU 114 is capable of generating an analogue RGB signal and an HDMI video signal on the basis of the display data. The analogue RGB signal is supplied to an external display via the RGB port 24. The HDMI output terminal 23 is capable of transmitting the HDMI video signal (uncompressed digital video signal) and a digital audio signal to the external display via one cable. The HDMI control circuit 119 is an interface configured to transmit the HDMI video signal and the digital audio signal to the external display via the HDMI output terminal 23.

The system controller 112 is a bridge device which connects the CPU 111 and each component. The system controller 112 includes a built-in serial ATA controller configured to control the hard disc drive (HDD) 117 and the optical disc drive (ODD) 118.

Devices such as the USB port 22, the wireless LAN module 121, the web camera 32, and the fingerprint sensor 15 are connected to the system controller 112.

The system controller 112 performs communications with each device connected via a bus.

The EC/KBC 130 is connected to the system controller 112 via a bus. The EC/KBC 130 is mutually connected to the charger IC 143 and the battery 20 via a serial bus.

The EC/KBC 130 is a power management controller configured to perform power management of the personal computer 10, and is embodied as a single-chip microcomputer including a built-in keyboard controller which controls the keyboard (KB) 13, the touchpad 14, and the like, for example. The EC/KBC 130 is equipped with a function of powering on/off the personal computer 10 according to an operation on the power-supply switch 16 by the user. Power-on/off control of the personal computer 10 is performed on the system power-supply circuit 141 by the EC/KBC 130.

The charger IC 143 is an IC configured to control the charging circuit 142 under control of the EC/KBC 130. The EC/KBC 130, the charger IC 143, and the system power-supply circuit 141 operate by power from the battery 20 or the AC adaptor 150 even during a period of time when the personal computer 10 is powered off.

The system power-supply circuit 141 generates power (operation power) to be supplied to each component, using power from the battery 20 or power from the AC adaptor 150 connected to the computer main body 11 as an external power supply. The system power-supply circuit 141 supplies power used to charge the battery 20 via the charging circuit 142.

The charging circuit 142 charges the battery 20 with power supplied via the system power-supply circuit 141 under control of the charger IC 143.

The measuring circuit 144 measures a current/voltage supplied to the system power-supply circuit 141 via the power-supply connector 21 (AC adaptor), and notifies the EC/KBC 130 of the measured current/voltage.

A description will now be given on operation of the peak shift function of the personal computer 10 according to the embodiment.

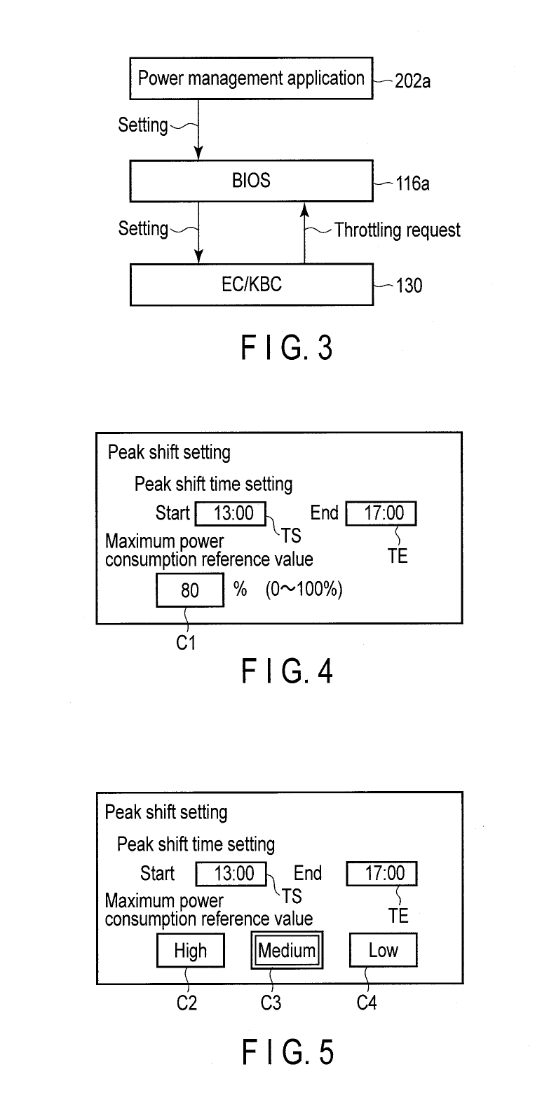

FIG. 3 illustrates a relationship of modules relating to the peak shift function of the embodiment. A description will be given on settings relating to the peak shift function.

A power management application 202a (power management application program 202) causes the LCD 31 to display a setting screen.

FIG. 4 is an exemplary diagram illustrating a peak shift setting screen of the embodiment. In the peak shift setting screen shown in FIG. 4, areas TS and TE for inputting start time and ending time for setting a peak shift time, and an area C1 for setting the maximum power consumption reference value during the peak shift time are provided. The user can input setting data to each of the areas TS, TE, and C1 by operating the keyboard 13, the touchpad 14, or the like.

A period of time with the highest demand for electricity is generally specified as the peak shift time. In the example shown in FIG. 4, the period from 13:00 to 17:00 is set as the peak shift time.

The maximum power consumption reference value represents the maximum power consumption value of the AC power supply (external power supply) during the peak shift time. The peak shift function of the embodiment saves power by controlling the power supply such that the amount of consumption of power from the AC power supply does not exceed the maximum power consumption reference value during the peak shift time, and reduces the period of time during which the personal computer 10 is driven by battery power, thereby avoiding significant shortening in the period of time during which the personal computer 10 can be powered by the battery after the peak shift time.

In the example shown in FIG. 4, the maximum power consumption reference value is specified by a percentage (%) with respect to the maximum power consumption of when the personal computer 10 is driven by AC power. FIG. 4 indicates that, when the maximum power consumption reference value is set to 0%, the personal computer 10 is powered by the battery during the peak shift time.

FIG. 5 is an exemplary diagram illustrating a peak shift setting screen. In the peak shift setting screen shown in FIG. 5, options C2, C3 and C4, which set the maximum power consumption reference value during the peak shift time to “high”, “medium”, and “low”, respectively, are provided. For example, if the maximum power consumption reference value is set to “high”, “middle”, and “low”, the maximum power consumption reference value is set to 80%, 60%, and 40%, respectively, of the maximum amount of power consumption of when the personal computer 10 is driven by AC power.

Setting data input by the power management application 202a is set in the EC/KBC 130 via the BIOS 116a. That is, setting data is stored in a non-volatile storage medium that can be accessed by the EC/KBC 130.

The above-described settings may be made not by the power management application 202a but by another utility program or the like.

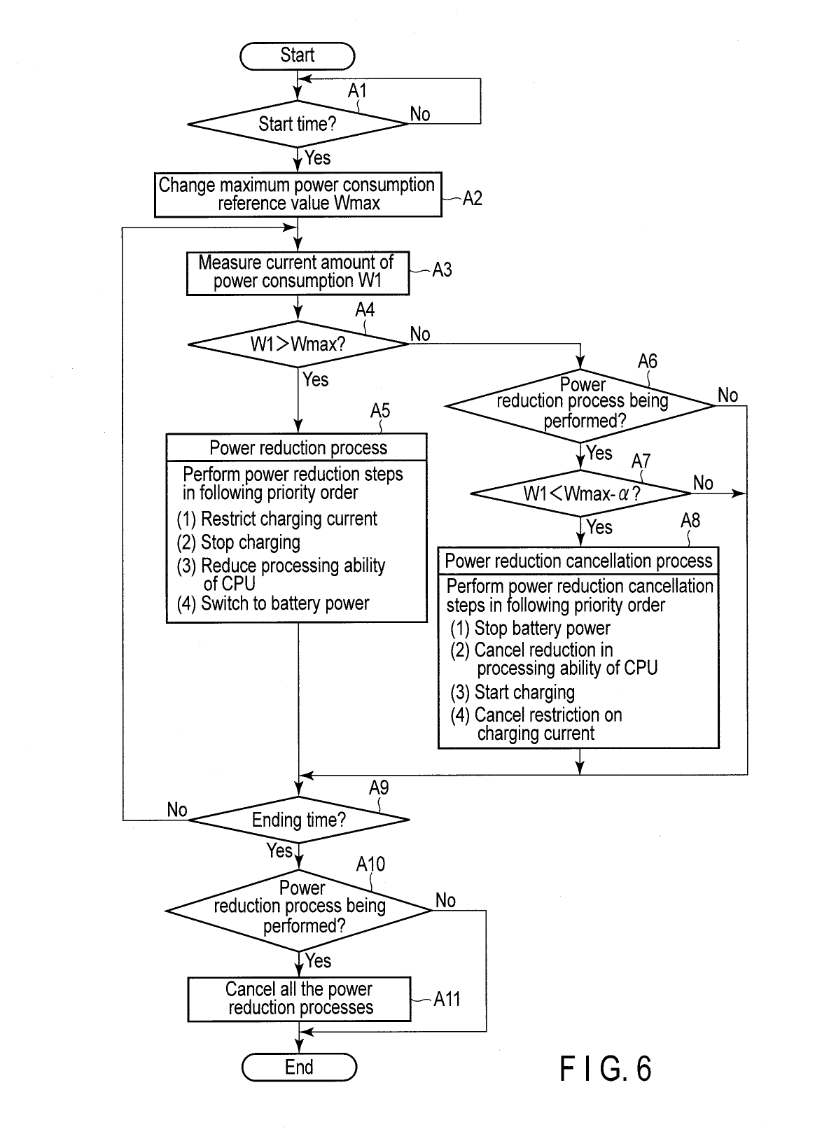

Power-saving control by the peak shift function of the embodiment will now be described with reference to the flowchart shown in FIG. 6.

Assume that the personal computer 10 is connected to an external power supply (AC power) via an AC adaptor 150, and is powered by the AC power supply.

The power management application 202a periodically acquires the current time via the OS 201, for example, and monitors whether the current time has reached the start time of the peak shift time. When the start time of the peak shift time has been reached, the power management application 202a notifies the EC/KBC 130 that the start time of the peak shift time has been reached via the BIOS 116a.

Upon receipt of notification that the start time of the peak shift time has been reached, the EC/KBC 130 sets the maximum power consumption reference value (Wmax) on the basis of setting data (step A2). That is, by letting the amount of power consumption not to exceed the maximum power consumption reference value (Wmax) in a power reduction process that will be described later, in which the maximum value of consumption of power from the AC power supply (external power supply) during the peak shift time is lowered to the maximum power consumption reference value (Wmax), power saving is achieved.

The EC/KBC 130 measures the current amount of power consumption (W1) on the basis of data on a current/voltage measured by the measuring circuit 144 and supplied from the power-supply connector 21 (AC adaptor) to the system power-supply circuit 141 (step A3). That is, the EC/KBC 130 measures the amount of consumption of power from the AC power supply.

The EC/KBC 130 determines whether the current amount of power consumption (W1) exceeds the maximum power consumption reference value (Wmax). When it is determined that the current amount of power consumption (W1) does not exceed the maximum power consumption reference value (Wmax) (No in step A4), the EC/KBC 130 continues the AC power.

When the current amount of power consumption (W1) exceeds the maximum power consumption reference value (Wmax) (Yes in step A4), on the other hand, the EC/KBC 130 performs a power reduction process that reduces the amount of consumption of power from the AC power supply (step A5).

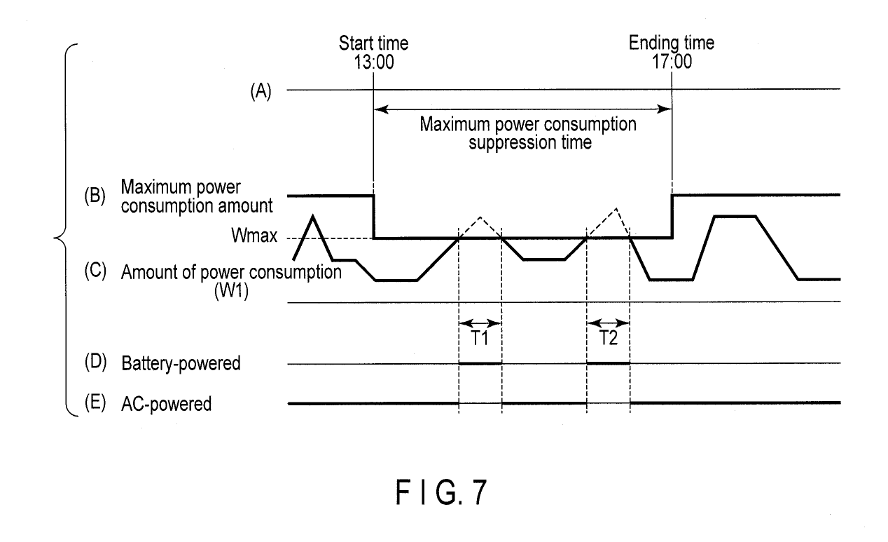

FIG. 7 illustrates a situation in which the current amount of power consumption (W1) exceeds the maximum power consumption reference value (Wmax) according to the embodiment.

The maximum amount of power from the AC power supply is reduced to the maximum power consumption reference value (Wmax), in order to make the peak shift time (from start time 13:00 to ending time 17:00) the maximum power consumption suppression time, as shown in (A) and (B) of FIG. 7. Accordingly, a period of time T1 or T2 occurs, in which the amount of power consumption (W1) exceeds the maximum power consumption reference value (Wmax).

In the power reduction process, the EC/KBC 130 causes a plurality of power-saving control steps (1), (2), (3), and (4), that will be described later, to be performed one by one, thereby suppressing the amount of power consumption (W1) from exceeding the maximum power consumption reference value (Wmax).

In the power reduction process, the EC/KBC 130 performs the power-saving control steps by giving priority in the order of (1), (2), (3), and (4), for example. That is, the EC/KBC 130 performs steps of (1) restricting a charging current (if the battery 20 is being charged), (2) stopping charging (if the battery 20 is being charged), (3) reducing the processing ability of the CPU 111, and (4) switching to battery power, one by one, until the amount of power consumption (W1) does not exceed the maximum power consumption reference value (Wmax).

It is to be noted that, when the amount of power consumption (W1) still exceeds the maximum power consumption reference value (Wmax) even after a predetermined period of time has elapsed after one of the power-saving control steps is performed, the EC/KBC 130 performs the next power-saving control step according to the priority order.

When the battery 20 is not charged to a predetermined charging amount, the EC/KBC 130 charges the battery 20 from the AC power supply via the charger IC 143. When a current of 1 ampere (A) is supplied to the battery 20 so as to charge the battery 20, for example, the EC/KBC 130 reduces the current to 500 mA by the restriction on charging current. The EC/KBC 130 restricts the current supplied from the charging circuit 142 to the battery 20 via the charger IC 143.

Even if the battery 20 is not charged with a predetermined amount of power by stop of charging, the EC/KBC 130 stops charging the battery 20. The EC/KBC 130 stops charging the battery 20 from the charging circuit 142 via the charger IC 143.

The EC/KBC 130 reduces the processing ability of the CPU 111 by lowering (or intermittently lowering) the operation frequency of the CPU 111 by notifying the BIOS 116a of a throttling request.

When switching is made to battery power, the EC/KBC 130 causes the system power-supply circuit 141 to switch from AC power to battery power via the charger IC 143.

While the four power-saving control steps have been described above by way of example, other power-saving control steps may be performed as well. For example, steps of lowering the operation frequency of the GPU 114, lowering the brightness of a backlight of the LCD 31, and stopping lighting of a backlight, a light emitting diode (LED), or the like of the keyboard 13 may be performed.

The order of priority of the above-described power-saving control steps (1), (2), (3), and (4) is determined in decreasing order of difficulty for the user to recognize change in operation situation of the personal computer 10 when executed. That is, the power-saving control steps (1) and (2) are difficult to be recognized by the user even when the user is using the personal computer 10, and are therefore given higher priority. The power-saving control step (4) is given the lowest priority in order to make the period of time during which the personal computer 10 can be powered by the battery after the peak shift time as long as possible.

When the power reduction process is being performed (Yes in step A6) and when the current amount of power consumption (W1) does not exceed a power value obtained by subtracting a hysteresis fixed value (α) from the maximum power consumption reference value (Wmax) (Yes in step A7), the EC/KBC 130 performs a power reduction cancellation process, in which the power-saving control steps performed by the power reduction process are cancelled (step A8).

In the power reduction cancellation process, the EC/KBC 130 cancels the above-described power-saving control steps (4), (3), (2), and (1) one by one in this order from the power-saving control step currently being executed. That is, in the power reduction cancellation process, the EC/KBC 130 causes the steps of (1) stopping battery power (switching to AC power), (2) cancelling lowering in processing ability of the CPU 111, (3) starting charging of the battery 20, and (4) cancelling restriction on the charging current to be performed, one by one.

Thereby, it is possible to shift to a normal operation state by making the amount of power consumption (W1) not to exceed the maximum power consumption reference value (Wmax).

In the description given above, the power reduction cancellation process is performed when the amount of power consumption (W1)<maximum power consumption reference value (Wmax)−α (where α is a hysteresis fixed value).

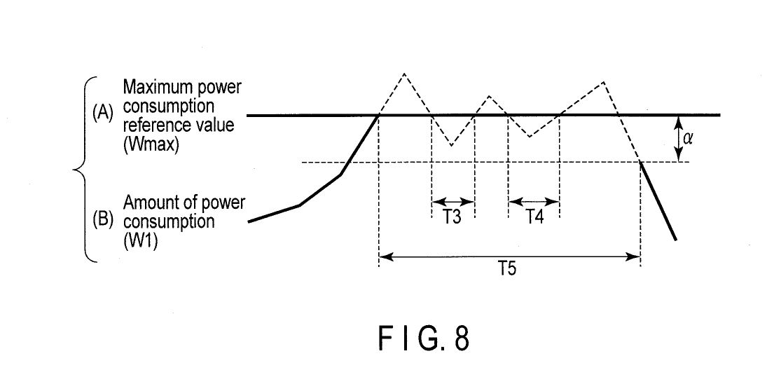

FIG. 8 illustrates a situation in which the power reduction cancellation process is performed according to the embodiment. As a result of performing a power reduction process, as shown in (B) of FIG. 8, even if the amount of power consumption (W1) does not exceed the maximum power consumption reference value (Wmax), as shown in (A) of FIG. 8, a situation can occur where the amount of power consumption does not decrease significantly and exceeds the maximum power consumption reference value (Wmax) again. When switching is made between the power reduction process and the power reduction cancellation process only on the basis of a result of comparison between the amount of power consumption (W1) and the maximum power consumption reference value (Wmax), a situation can occur where switching is frequently made between the power reduction process and the power reduction cancellation process. In order to avoid such a situation, when the amount of power consumption has been reduced to be lower than a power value obtained by subtracting a hysteresis fixed value (α) from the maximum power consumption reference value (Wmax), as shown in FIG. 8, a power reduction cancellation process is performed.

As a result, as shown in FIG. 8, a power reduction cancellation process is not performed in periods T3 and T4, and a power reduction process is continuously performed in period T5. After the period T5, the process can be shifted to a power reduction cancellation process.

The EC/KBC 130 repeatedly performs the above-described process (steps A3-A8) until the ending time of the peak shift time has been reached.

Upon receipt of a notification from the power management application 202a via the BIOS 116a that the ending time has been reached (Yes in step A9), the EC/KBC 130 determines whether a power reduction process is being performed. When the system is off, the EC/KBC 130 determines whether the peak shift time has ended.

When the power reduction process is being performed (Yes in step A10), the EC/KBC 130 cancels all the power-saving control steps in the power reduction process, and ends the process by the peak shift function.

Thus, since the personal computer 10 according to the embodiment sets the maximum power consumption reference value (Wmax) during the peak shift time and is not powered by the battery if the amount of power consumption (W1) does not exceed the maximum power consumption reference value (Wmax), the power supplied to the battery 20 is not consumed. Further, even during the peak shift time, it is possible to charge the battery 20. It is therefore possible to secure a period of time during which the personal computer 10 can be powered by the battery of approximately the same length as that after the personal computer 10 is powered by the AC power supply, even at the point in time immediately after the peak shift time has ended.

Further, even when the amount of power consumption (W1) exceeds the maximum power consumption reference value (Wmax) during the peak shift time, since the power-saving control step to switch to battery power is given with lower priority in the power reduction process, the battery 20 is charged/discharged less frequently. It is therefore possible to reduce the risk of deterioration in properties, such as reduction in charging capacity, which occurs by frequently repeating charging/discharging of the battery 20.

Moreover, in contrast to the conventional peak shift function in which, when the battery drops to a level lower than a reference value, switching is made to AC power and electricity is supplied without restriction, the peak shift function of the personal computer 10 of the embodiment performs control such that the amount of consumption of power from the AC power supply does not exceed the maximum power consumption reference value (Wmax) during the peak shift time, thereby reliably defining the amount of consumption of power from the AC power supply in the personal computer 10.

In the description given above, when the current amount of power consumption (W1) exceeds the maximum power consumption reference value (Wmax), the amount of power consumption is reduced step by step in the power reduction process. It is also possible, however, to switch from AC power to battery power without performing steps (1)-(3) of the power reduction process. Alternatively, it is also possible to perform steps (1) and (2) of the power reduction process during the peak shift time so as to reduce the amount of power consumption, switch to battery power by performing step (4) of the power reduction process when the current amount of power consumption (W1) exceeds the maximum power consumption reference value (Wmax), and then perform step (3) of the power reduction process when W1 exceeds a predetermined threshold value. The EC/KBC 130 may change the priority order of steps (1)-(4) and the like in the power reduction process according to user settings.

For example, AC-powered is continued when the current amount of power consumption (W1) does not exceed the maximum power consumption reference value (Wmax) during the peak shift time, as shown in (E) of FIG. 7, and switching is made to battery-powered only in periods T1 and T2, in which the current amount of power consumption (W1) exceeds the maximum power consumption reference value (Wmax), as shown in (D) of FIG. 7.

Thus, by switching to battery power only in periods T1 and T2 in which the current amount of power consumption (W1) exceeds the maximum power consumption reference value (Wmax) during the peak shift time, it is possible to minimize the amount of consumption of power supplied to the battery 20. It is therefore possible to secure a period of time during which the personal computer 10 can powered by the battery even at the point in time immediately after the peak shift time has ended, since the amount of charge of the battery 20 is not significantly reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a setting module configured to set a power consumption reference value for a predetermined period of time;
a determination module configured to determine whether an amount of power consumption of an external power supply exceeds the power consumption reference value in the predetermined period of time; and
a control module configured to cause a power reduction process to be performed when the amount of power consumption is determined as exceeding the power consumption reference value, the power reduction process reducing the amount of power consumption of the external power supply.

2. The electronic device of claim 1, wherein the control module is configured to switch from an external power supply drive to a battery power drive.

3. The electronic device of claim 1, wherein the control module is configured to cause a first power reduction process to be performed and a second power reduction process different from the first power reduction process to be performed when the amount of power consumption exceeds the power consumption reference value.

4. The electronic device of claim 3, wherein the control module is configured to switch from an external power supply drive to a battery power drive in the second power reduction process.

5. The electronic device of claim 1, wherein the control module is configured to cause the power reduction process to be performed until the amount of power consumption is reduced to a predetermined value lower than the power consumption reference value, after the amount of power consumption is determined as exceeding the power consumption reference value.

6. A power-supply control method comprising:
setting a power consumption reference value for a predetermined period of time;
determining whether an amount of power consumption of an external power supply exceeds the power consumption reference value in the predetermined period of time; and
performing a power reduction process when the amount of power consumption is determined as exceeding the power consumption reference value, the power reduction process reducing the amount of power consumption of the external power supply.

7. The power-supply control method of claim 6, further comprising switching from an external power supply drive to a battery power drive.

8. The power-supply control method of claim 6, further comprising performing a first power reduction process and a second power reduction process different from the first power reduction process when the amount of power consumption exceeds the power consumption reference value.

9. The power-supply control method of claim 8, further comprising switching from an external power supply drive to a battery power drive in the second power reduction process.

10. The power-supply control method of claim 6, further comprising performing the power reduction process until the amount of power consumption is reduced to a predetermined value lower than the power consumption reference value, after the amount of power consumption is determined as exceeding the power consumption reference value.
